(19) United States
(12) Patent Application Publication
(10) Pub. No.: US 2016/0110653 A1
(43) Pub. Date: Apr. 21, 2016

(54) METHOD AND APPARATUS FOR PREDICTING A SERVICE CALL FOR DIGITAL PRINTING EQUIPMENT FROM A CUSTOMER

(71) Applicant: Xerox Corporation, Norwalk, CT (US)

(72) Inventors: Diane Marie Foley, Palmyra, NY (US); Juan Li, Webster, NY (US); Bryan R. Dolan, Webster, NY (US); Vladislav Skorokhod, Vaughan (CA); Brian Robert Conrow, Webster, NY (US); Connie Treese Gaylord, Macedon, NY (US)

(21) Appl. No.: 14/518,674

(22) Filed: Oct. 20, 2014

(51) Int. Cl. G06N 7/00; G06N 99/00

(52) U.S. Cl. CPC G06N 7/005; G06N 99/005

(57) ABSTRACT

A method, non-transitory computer readable medium, and apparatus for predicting a service call for digital printing equipment from a customer are disclosed. For example, the method detects a triggering event based upon a number of detections of an event on a digital printing equipment exceeding a threshold within a predefined time period, wherein the number of detected events on the digital printing equipment exceeding the threshold within the predefined time period is indicative of an impending soft failure, calculates a probability that the customer will place the service call due to the impending soft failure within a second predefined period of time based on a fusion of a hazard model of the digital printing equipment, a customer behavior model and the number of detections of the event in response to the triggering event being detected and determines an action based upon the probability using a cost based utility function.

The present disclosure relates generally to predictive and proactive maintenance of equipment and, more particularly, to a method and apparatus for predicting a service call for digital printing equipment from a customer.

### BACKGROUND

The potential for using device data from electromechanical systems to greatly improve the efficiency of device repair services is widely understood. Companies have collected massive data repositories of device data in anticipation of the opportunity to modernize their repair services in order to provide a superior customer experience at a reasonable cost.

In capital intensive or mission critical industries, equipment has been designed to support remote monitoring, diagnostics, prognostics and repair through appropriately placed sensors transmitting signals about the physical state of the part. These sensors are placed to monitor and detect failure for the specific part the sensors are assigned to monitor.

However, for legacy or non-mission critical equipment in consumer or business locations, devices and their associated data have been designed for a service model of run to failure with warranty, customer replaceable parts (CRU) or light on-site repair. Occasional upsets in device availability are not expected to have serious consequences for the user. The sensors and associated data design described above for mission critical equipment are too costly to embed in legacy or non-mission critical equipment. As a result, upsets or failures for legacy equipment are usually captured after the failure occurs with little or no warning of any impending failure.

Today, as a result of the many changes Internet commerce has brought about, customers no longer expect degraded function or unexpected downtime from their devices. Businesses are eager to compete by satisfying that expectation of customers.

### SUMMARY

According to aspects illustrated herein, there are provided a method, a non-transitory computer readable medium, and an apparatus for predicting a service call for digital printing equipment from a customer. One disclosed feature of the embodiments is a method that detects a triggering event based upon a number of detections of an event on a digital printing equipment exceeding a threshold within a predefined time period, wherein the number of detections of the event on the digital printing equipment exceeding the threshold within the predefined time period is indicative of an impending soft failure, calculates a probability that the customer will place the service call due to the impending soft failure within a second predefined period of time based on a fusion of a hazard model of the digital printing equipment, a customer behavior model and the number of detections of the event in response to the triggering event being detected and determines an action based upon the probability using a cost based utility function.

Another disclosed feature of the embodiments is a non-transitory computer-readable medium having stored thereon a plurality of instructions, the plurality of instructions including instructions which, when executed by a processor, cause the processor to perform operations that detects a triggering event based upon a number of detections of an event on a digital printing equipment exceeding a threshold within a predefined time period, wherein the number of detections of the event on the digital printing equipment exceeding the threshold within the predefined time period is indicative of an impending soft failure, calculates a probability that the customer will place the service call due to the impending soft failure within a second predefined period of time based on a fusion of a hazard model of the digital printing equipment, a customer behavior model and the number of detections of the event in response to the triggering event being detected and determines an action based upon the probability using a cost based utility function.

Another disclosed feature of the embodiments is an apparatus comprising a processor and a computer readable medium storing a plurality of instructions which, when executed by the processor, cause the processor to perform operations that detects a triggering event based upon a number of detections of an event on a digital printing equipment exceeding a threshold within a predefined time period, wherein the number of detections of the event on the digital printing equipment exceeding the threshold within the predefined time period is indicative of an impending soft failure, calculates a probability that the customer will place the service call due to the impending soft failure within a second predefined period of time based on a fusion of a hazard model of the digital printing equipment, a customer behavior model and the number of detections of the event in response to the triggering event being detected and determines an action based upon the probability using a cost based utility function.

### BRIEF DESCRIPTION OF THE DRAWINGS

The teaching of the present disclosure can be readily understood by considering the following detailed description in conjunction with the accompanying drawings, in which:

FIG. 1 illustrates a block diagram of a system of the present disclosure;

FIG. 2 illustrates an example survival chart of the present disclosure;

FIG. 3 illustrates an example flowchart of one embodiment of a method for predicting a service call for digital printing equipment from a customer; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method and non-transitory computer-readable medium for predicting a service call for digital printing equipment from a customer. As discussed above, legacy or non-mission critical equipment in consumer or business locations, devices and their associated data have been designed for a service model of run to failure with warranty, customer replaceable parts (CRU) or light on-site repair. Occasional upsets in device availability are not expected to have serious consequences for the user. The sensors and associated data design described above for mission critical equipment are too costly to embed in legacy or non-mission critical equipment. As a result, upsets or failures for legacy equipment are usually captured after the failure occurs with little or no warning of any impending failure.

Embodiments of the present disclosure provide a way to anticipate a possible failure of the digital printing equipment and predict a service call from the customer based on certain monitored activities of the digital printing equipment. For example, data collected about certain actions or activities at the digital printing equipment can be transformed into a prediction that the digital printing equipment is about to have a soft failure (e.g., a failure that is not caused by an actual failure of a part or a piece of hardware within the digital printing equipment). In one embodiment, a soft failure may be defined as a failure to meet a customer's expectations of device performance and does not necessarily imply a part has failed. Noise, image quality, slow performance, excessive jams are examples of soft failures.

Other types of failures may include undetectable failures, impending failures and hard failures. A soft failure may be an undetectable failure or an impending failure. For example, an undetectable failure may be a malfunction that the customer has not detected yet, but will do so if the malfunction reoccurs. Software and network errors may be examples of undetectable failures.

An impending failure may be a failure that can be accurately forecasted in the near future. Solenoid or motor failures may be examples of impending failures.

A hard failure means a part has failed and the customer is experiencing degraded performance according to the manufacturer's definition. The embodiments of the present disclosure can handle all the different types of failures described above; however, the embodiments of the present disclosure provide a unique ability to handle soft failures. By providing the ability to handle multiple classes of failure, including soft failures, the embodiments of the present disclosure are able to make enough predictions of customer's calls to make a viable service improvement. Based on a probability of the predicted soft failure, an appropriate notification may be sent to the customer and/or an action may be taken with the customer in advance of the service call from the customer that is predicted.

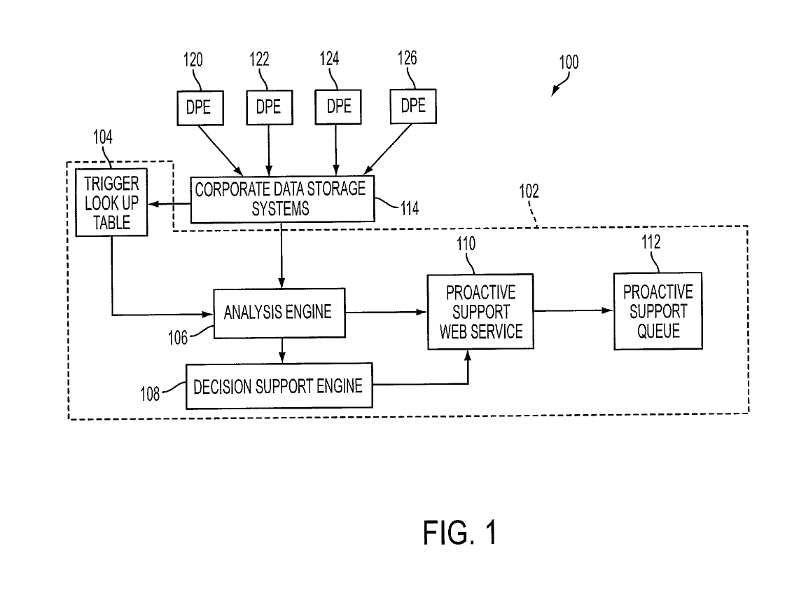

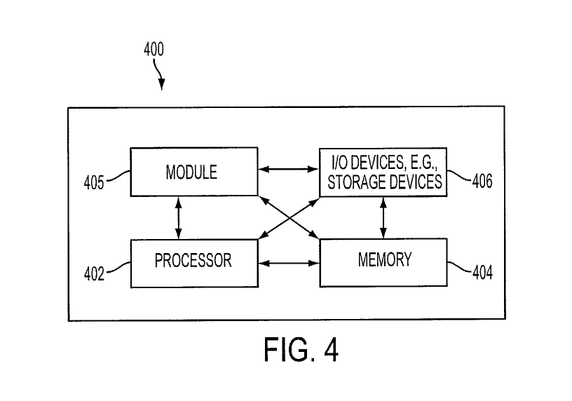

FIG. 1 illustrates an example system 100 of the present disclosure. In one embodiment, the system 100 includes one or more corporate data storage systems 114 that collect data from a plurality of different digital printing equipment (DPE) 120, 122, 124 and 126, a trigger look up table 104, an analysis engine 106, a decision support engine 108, a proactive support web service 110 and a proactive support queue 112. In one embodiment, the trigger look up table 104, the analysis engine 106, the decision support engine 108, the proactive support web service 110 and the proactive support queue 112 may be deployed as part of a single application server (AS) 102 or general purpose computer (e.g., illustrated in FIG. 4) represented by the dashed lines in FIG. 1.

In one embodiment, the corporate data storage system 114 may include physical storage drives and databases or may be a cloud based data storage system. Although four different DPEs are illustrated in FIG. 1, it should be noted that any number of DPEs may be deployed. In one embodiment, the DPEs 120, 122, 124 and 126 may be any type of DPE including, for example, a multi-function device (MFD), a printer, a laser printer, a copy machine, and the like.

In one embodiment, the DPEs 120, 122, 124 and 126 may be deployed at various different customer sites. For example, the DPE 120 may be at a customer site A, the DPEs 122 and 124 may be at a customer site B and the DPE 126 may be at a customer site C. In one embodiment, each one of the DPEs 120, 122, 124 and 126 may be in communication with the corporate data storage system 114 via either a wired or wireless connection. For example, all of the event codes and calibration events occurring at the DPEs 120, 122, 124 and 126 may be sent to the corporate data storage system 114.

In one embodiment, the trigger look up table 104 may include a threshold value for each one of a plurality of different events that is being monitored. In one embodiment, the threshold value may be associated with a rolling time period or incremental time period (e.g., continuous 1 hour time intervals or discrete 1 hour time periods). In one embodiment, the different events may include event codes (e.g., error codes or fault codes) generated by the DPEs 120, 122, 124 and 126 or a calibration event. For example, the event codes may include a code generated for a paper jam, a code generated for an abrupt power cycling, a code generated for a belt slip, and the like. The calibration event may be data regarding each time the DPEs 120, 122, 124 and 126 have a contrast adjusted, a brightness adjusted, a size of the photocopy adjusted, and the like.

In one embodiment, the different events that are monitored may be selected based on an analysis for a strength of association with a customer call. In other words, not all events need to be monitored if some events do not lead to a service call from a customer. Alternatively, those events that lead to the most number of service calls are the events that should be monitored. Techniques such as conditional mean comparison, Chi-squared test, G-test, principle component analysis (PCA) or discriminate analysis can be used to screen which events have a better than random association with service calls from customers.

As noted above, each one of the events may have a different threshold value. For example, paper jams may have a threshold value of ten for every one hour interval, a contrast adjustment may have a threshold value of 100 for every 24 hour interval, and the like. When a threshold value for a particular event is breached, an indication that an event has been triggered may be sent to an analysis engine 106 to begin analysis of the event.

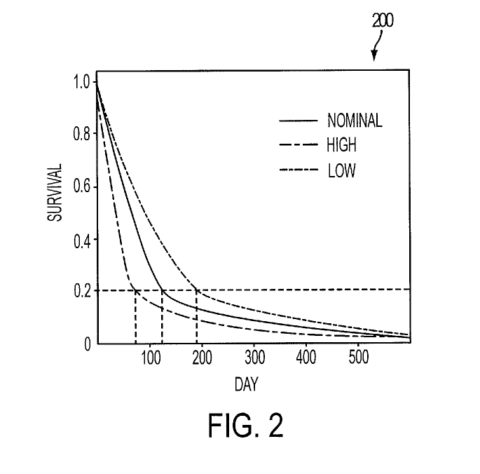

In one embodiment, the analysis engine 106 may perform analysis on various types of data to calculate a probability that a service call will be received from the customer within a predefined time period (e.g., within the next 20 days, within the next month and so on). In one embodiment, the various types of data may include influential factors on a DPE including, time, usage profiles, contract types, geographical location and the like. The hazard model may be applied to the data about the DPE to obtain a survival rate chart 200 illustrated in FIG. 2. The survival rate chart provides probabilities that a particular DPE will survive over a number days for nominal, high and low usage. These percentages may be used by the analysis engine 106 and fused with other data to obtain an overall probability of a service call from a customer, as discussed below.

In one embodiment any type of hazard model may be applied. For example, the hazard models may include a Cox proportional hazards model, an Extended Cox model for time-dependent covariates, an Additive model, a Stratified Cox PH model, an Accelerated failure time model, and the like.

In one embodiment, the customer behavior model may provide a probability that the customer may call based on past service calls for the same event. For example, past service call data may be collected and categorized based on the event and probabilities may be calculated based on the past data.

In one embodiment, the number of detections for a particular event that are stored in the corporate data storage system 114 may be used to provide a probability that the event will lead to a service call. In one embodiment, the analysis engine may then fuse all three types of data together and apply a learning model to the fused data.

In one embodiment, an unsupervised or a supervised learning model may be applied. In one embodiment, the unsupervised learning model may be outlier detection. In one embodiment, the supervised learning model may be at least one of a decision tree model, a random forest model, a logistic regression model, a support vector machine model, a Bayesian Hierarchical model or a case based reasoning model.

Once the analysis engine 106 calculates a probability that a customer will place a service call due to an impending soft failure, the event and associated probability may be placed in a proactive support web service 110 that performs a cost base utility function analysis. In other words, based on the probability that a service call will be received from the customer, an appropriate action is taken with a minimal cost. For example, if the probability is low, no action may be taken. If the probability is medium, an action with a moderate cost may be taken (e.g., sending a message). However, if the probability is high, then a more expensive action may be taken (e.g., using live technicians to contact the customer and schedule maintenance appointments or provide direct customer support).

In one embodiment, for high probability events, the decision support engine 108 may be used to find recommended fixes or actions to prevent or fix the impending soft failure. In one embodiment, the decision support engine 108 may include a knowledge base and solutions of fix actions taken by the customer, by a remote specialist, by an on-site engineer, and the like.

The recommended fixes along with the event in question are then placed in a proactive support queue 112. The customer may then be contacted to confirm that the customer is experiencing the predicted soft failure. If the customer is experiencing the soft failure, then the customer may be provided with the recommended fix or solutions to prevent or fix the soft failure that was predicted.

In one embodiment, based on the result of the contact to the customer, the threshold for the event in the trigger look up table may be adjusted. For example, if the customer indicated that they are not experiencing the soft failure or were not going to call, the threshold may be increased to prevent another false positive. Alternatively, if a customer places a service call before the prediction is made, then the threshold may be reduced for the particular event.

Thus, the system 100 of the present disclosure allows a service provider to predict the likelihood of a customer placing a service call for a DPE 120, 122, 124 or 126 that is being monitored based on a number of detections of a particular event. The proactive notification to customers based on the probability that the customer would place a service call for a particular event reduces costs and down time of DPEs 120, 122, 124 and 126 and increases customer satisfaction.

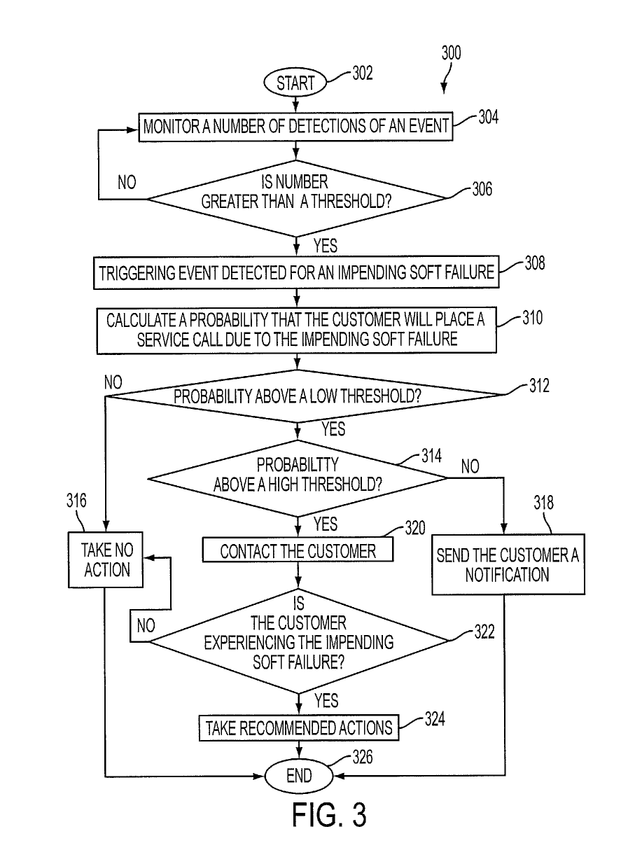

FIG. 3 illustrates a flowchart of a method 300 for predicting a service call for digital printing equipment form a customer. In one embodiment, one or more steps or operations of the method 300 may be performed by the AS 102 or a general-purpose computer as illustrated in FIG. 4 and discussed below.

At step 302 the method 300 begins. At step 304, the method 300 monitors a number of detections of an event. In one embodiment, the event may be an error code, an event code, a calibration event, and the like. In one embodiment, the number of detections is accumulated for each specific event for a particular one of the plurality of digital printing equipment for a particular customer. For example, the method 300 may monitor a plurality of different digital printing equipment for customer A and a plurality of different digital printing equipment for customer B. The method 300 may monitor a number of paper jam error codes for each one of the plurality of different digital printing equipment for customer A and customer B, a number of times the calibration was adjusted on each one of the plurality of different digital printing equipment for customer A and customer B, and the like.

At step 306, the method 300 determines if the number of detections is greater than a threshold. If the number of detections is not greater than the threshold value, the method 300 may return to step 304 and continue to monitor the number of detections of an event. However, if the number of detections is greater than a threshold value, then a triggering event may be detected and the method 300 may proceed to step 308.

In one embodiment, the number of detections may be measured against the threshold for a predetermined time period (e.g., within a 1 hour interval, within a 24 hour interval, within a 1 week interval, and the like). In one embodiment, each one of the events may be associated with a different threshold value. For example, the threshold value for paper jam error codes may be 20 within a 24 hour time period and the threshold value for power cycling may be 10 within a 12 hour time period and so on.

At step 308, the triggering event is detected for an impending soft failure. For example, the monitored events may not be directly correlated to any type of specific failure. However, embodiments of the present disclosure have transformed the monitored events into a prediction of a soft failure and a prediction of a service call from the customer. In one embodiment, a soft failure may be defined as a failure that is not caused by a failed hardware component within the digital printing equipment. Examples of soft failures may include a misalignment, an incompatible toner or ink being used, a low amount of ink or toner remaining, a software incompatibility issue, and the like).

For example, data regarding a number of times calibration is adjusted on a printer is not directly indicative of a failure of the printer. For example, users may adjust the contrast or darkness of a print job for various reasons. In addition, the calibration event does not indicate that any specific piece of hardware or component within the printer has failed.

However, the present disclosure may transform data such as calibration event data into a prediction that the printer is about to experience a soft failure. For example, the embodiments of the present disclosure may interpret a high number of calibration events within a predefined time period as indicating an impending soft failure on the printer.

At step 310, the method 300 calculates a probability that the customer will place a service call due to the impending soft failure. In one embodiment, the probability may be calculated based upon a fusion of a hazard model of the digital printing equipment, a customer behavior model and the number of detections of the event. In one embodiment, fusion of the models may be defined as combining data or probabilities from each one of the models into a single data table such that the learning algorithms may be applied to the fused data. In one embodiment, the probability may be a probability that the customer will place the service call within a predefined time period (e.g., within 20 days, one month and so on).

In one embodiment, the hazard model of the digital printing equipment may provide a survival curve for the digital printing equipment (e.g., as illustrated in FIG. 2). In one embodiment, the behavior model may include data on how many times the customer has called for a similar event or the same event.

After the hazard model of the digital printing equipment, the customer behavior model and the number of detections of the event are fused together, a learning model may be applied to the fused data to obtain a probability value. In one embodiment, an unsupervised or a supervised learning model may be applied. In one embodiment, the unsupervised learning model may be outlier detection. In one embodiment, the supervised learning model may be at least one of a decision tree model, a random forest model, a logistic regression model, a support vector machine model, a Bayesian Hierarchical model or a case based reasoning model.

At step 312, the method 300 may determine whether the probability is above a low threshold. In one embodiment, the low threshold may be set by a service provider of the method 300. For example, the low threshold may be set at a 20% probability. If the probability is below a low threshold, then the method proceeds to step 316.

At step 316, the method 300 takes no action as the probability of a service call for the detected event is too low. In other words, the customer typically does not place a service call for a soft failure that is correlated to the event in question that triggered the analysis. The method then proceeds to step 326, where the method 300 ends.

Returning back to step 312, if the probability is above the low threshold, then the method 300 may proceed to step 314. At step 314, the method 300 determines whether the probability is above a high threshold. The high threshold may also be set by a service provider of the method 300. For example the high threshold may be set to 80%. If the probability is below the high threshold value, the method 300 may proceed to step 318.

At step 318, the method 300 may send the customer a notification. For example, the probability predicts there is a medium probability that the customer will place a service call. In other words, the customer may have placed service calls occasionally in the past for the event in question. Thus, based on the cost to service the event, a notification that includes possible self-help solutions or remedies to the impending soft-failure may be sufficient to help the customer. In one embodiment, the notification may be an email, an instant message, a letter and the like. The method 300 then proceeds to step 326 where the method 300 ends.

Returning back to step 314, if the method 300 determines that the probability is above the high threshold, then the method 300 may proceed to step 320. At step 320, the method 300 contacts the customer. For example, there is high probability that the customer may place a service call for the impending soft failure. In one embodiment, the action of contacting the customer may be placed in a proactive queue for customers that need to be contacted.

At step 322, the method 300 determines if the customer is experiencing the impending soft failure after the customer is contacted. For example, a proactive telephone call may be placed to the customer to indicating that an impending soft failure has been detected and ask if the customer is experiencing the soft failure that is predicted. If the customer is not experiencing the soft failure, then the triggering event may have been a false alarm and the method 300 proceeds to step 316 and takes no action.

However, if the customer does confirm that they are experiencing the soft failure, the method 300 may proceed to step 324. At step 324, the method 300 may take one or more recommended actions to prevent or fix the soft failure. In one embodiment, a knowledge database with known solutions and recommended fixes may be used to proactively prevent the impending soft failure. The method 300 proceeds to 326 where the method 300 ends.

In one embodiment, the steps 312 and 314 may be considered to be part of the cost utility function analysis. In other words, based on the probability that a service call will be received from the customer, an appropriate action is taken with a minimal cost. For example, if the probability is medium an action with a moderate cost may be taken (e.g., sending a message). However, if the probability is high, then a more expensive action may be taken (e.g., using live technicians to contact the customer and schedule maintenance appointments or provide direct customer support).

As a result, the embodiments of the present disclosure transform data associated with events at digital printing equipment into data that is indicative of an impending soft failure. The data is transformed to predict a service call from a customer to proactively contact the customer before the customer places the service call. In other words, the monitored event data without the present transformation would only convey the specific event has occurred (e.g., a paper jam, a calibration event, a power cycling, and the like) and the likelihood of a call given that a single event has occurred is no better than random.

Furthermore, the embodiments of the present disclosure improve the functioning of an application server or computer by allowing the application server to be able to predict that a service call from the customer is likely to happen. The functions of the application server and the computer are improved to proactively contact customers due to the prediction of an impending soft failure from ordinary event data that is collected and monitored.

It should be noted that although not explicitly specified, one or more steps, functions, or operations of the method 300 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIG. 3 that recite a determining operation, or involve a decision, do not necessarily require that both branches of the determining operation be practiced. In other words, one of the branches of the determining operation can be deemed as an optional step.

FIG. 4 depicts a high-level block diagram of a general-purpose computer suitable for use in performing the functions described herein. As depicted in FIG. 4, the system 400 comprises one or more hardware processor elements 402 (e.g., a central processing unit (CPU), a microprocessor, or a multi-core processor), a memory 404, e.g., random access memory (RAM) and/or read only memory (ROM), a module 405 for predicting a service call for digital printing equipment from a customer, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the general-purpose computer may employ a plurality of processor elements. Furthermore, although only one general-purpose computer is shown in the figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 405 for predicting a service call for digital printing equipment from a customer (e.g., a software program comprising computer-executable instructions) can be loaded into memory 404 and executed by hardware processor element 402 to implement the steps, functions or operations as discussed above in connection with the exemplary method 300. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for predicting a service call for digital printing equipment from a customer (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for predicting a service call for digital printing equipment from a customer, comprising:
detecting, by a processor, a triggering event based upon a number of detections of an event on the digital printing equipment exceeding a threshold within a predefined time period, wherein the number of detections of the event on the digital printing equipment exceeding the threshold within the predefined time period is indicative of an impending soft failure;
calculating, by the processor, a probability that the customer will place the service call due to the impending soft failure within a second predefined period of time based on a fusion of a hazard model of the digital printing equipment, a customer behavior model and the number of detections of the event in response to the triggering event being detected; and
determining, by the processor, an action based upon the probability using a cost based utility function.

2. The method of claim 1, wherein the cost based utility function balances the action based upon a cost associated with the action.

3. The method of claim 1, wherein the action comprises taking no action when the probability is below a low threshold.

4. The method of claim 3, wherein the action comprises sending a notification to the customer with a self-help solution if the impending soft failure occurs when the probability is above the low threshold but below a high threshold.

5. The method of claim 4, wherein the action comprises contacting the customer when the probability is above the high threshold.

6. The method of claim 5, wherein the contacting the customer comprises scheduling a service appointment to fix the impending soft failure.

7. The method of claim 1, wherein the event is not directly correlated to the impending soft failure.

8. The method of claim 1, wherein the event comprises an event code or a calibration event.

9. The method of claim 1, wherein the calculating is performed using an unsupervised learning model or a supervised learning model.

10. The method of claim 9, wherein the unsupervised learning model comprises an outlier detection and the supervised learning model comprises at least one of: a decision tree model, a random forest model, a logistic regression model, a support vector machine model, a Bayesian Hierarchical model or a case based reasoning model.

11. The method of claim 1, wherein the threshold for the triggering event is adjusted based on a response to contacting the customer.

12. A non-transitory computer-readable medium storing a plurality of instructions which, when executed by a processor, cause the processor to perform operations for predicting a service call for digital printing equipment from a customer, the operations comprising:
detecting a triggering event based upon a number of detections of an event on the digital printing equipment exceeding a threshold within a predefined time period, wherein the number of detections of the event on the digital printing equipment exceeding the threshold within the predefined time period is indicative of an impending soft failure;
calculating a probability that the customer will place the service call within a second predefined period of time based on a fusion of a hazard model of the digital printing equipment, a customer behavior model and the number of detections of the event in response to the triggering event being detected; and
determining an action based upon the probability using a cost based utility function.

13. The non-transitory computer-readable medium of claim 12, wherein the cost based utility function balances the action based upon a cost associated with the action.

14. The non-transitory computer-readable medium of claim 12, wherein the action comprises taking no action when the probability is below a low threshold, wherein the action comprises sending a notification to the customer with a self-help solution when the impending soft failure occurs when the probability is above the low threshold but below a high threshold and wherein the action comprises contacting the customer when the probability is above the high threshold.

15. The non-transitory computer-readable medium of claim 12, wherein the event is not directly correlated to the impending soft failure.

16. The non-transitory computer-readable medium of claim 12, wherein the event comprises a fault code, an error code or a calibration event.

17. The non-transitory computer-readable medium of claim 12, wherein the calculating is performed using an unsupervised learning model or a supervised learning model.

18. The non-transitory computer-readable medium of claim 17, wherein the unsupervised learning model comprises an outlier detection and the supervised learning model comprises at least one of: a decision tree model, a random forest model, a logistic regression model, a support vector machine model, a Bayesian Hierarchical model or a case based reasoning model.

19. The non-transitory computer-readable medium of claim 12, wherein the threshold for the triggering event is adjusted based on a response to contacting the customer.

20. A method for predicting a service call for digital printing equipment from a customer, comprising:
continuously monitoring, by a processor, events of each one of a plurality of digital printing equipment for a plurality of different customers, wherein the events comprise an event code or a calibration event that is not directly correlated to a soft failure, wherein the soft failure is not caused by a hardware failure within any one of the plurality of digital printing equipment;
detecting, by the processor, a triggering event based upon a number of detections of an event on the digital printing equipment of the plurality of digital printing equipment for the customer of the plurality of customers exceeding a threshold within a predefined time period, wherein the number of detections of the event on the digital printing equipment exceeding the threshold within the predefined time period is indicative of an impending soft failure;
calculating, by the processor, a probability that the customer will place the service call due to the impending soft failure within a second predefined period of time in response to the triggering event being detected, wherein the calculating comprises:
applying, by the processor, a hazard model to the digital printing equipment to obtain a survival rate chart for the digital printing equipment;
obtaining, by the processor, a behavior model for the customer, wherein the behavior model provides information regarding prior service calls placed by the customer for the event;
fusing, by the processor, data from the survival rate chart, the behavior model and the number of detections of the event; and
applying, by the processor, a unsupervised learning model or a supervised learning model on the data that is fused to calculate the probability that the customer will place the service call;
comparing, by the processor, the probability to a low threshold and a high threshold; and
initiating, by the processor, an action when the probability is above the low threshold or the high threshold using a cost based utility function.
